(19) United States
(12) Patent Application Publication
(10) Pub. No.: US 2012/0241261 A1
(43) Pub. Date: Sep. 27, 2012

(54) SEMI-HYDRAULIC BAKE FOR BICYCLE

(75) Inventor: SZU-FANG TSAI, CHANGHUA (TW)

(73) Assignee: TEKTRO TECHNOLOGY CORPORATION, CHANGHUA (TW)

(21) Appl. No.: 13/070,494

(22) Filed: Mar. 24, 2011

(51) Int. Cl. F16D 55/226; B62L 3/02

(52) U.S. Cl. 188/24.21

(57) ABSTRACT

A semi-hydraulic brake has at least one braking cable and one connection rod; at least one pushing rod, at least one piston, at least one elastic element and at least one tube; and a set of main pistons, a set of brake pads and a disc. When the braking handlebar pulls the braking cable, the connection rod is driven to move toward the braking cable; the pushing rod is driven by the connection rod and meanwhile to push the piston and come to compress the elastic element. The braking liquid inside the hydraulic cylinder is pushed toward respective main pistons of the braking unit through the tube so that the respective main pistons move toward the disc. The respective brake pads simultaneously move toward the disc. Thereby, the braking effect over a front wheel and a rear wheel can be achieved by using a single hydraulic cylinder.

### BACKGROUND OF THE INVENTION

1. Field of the Invention

The present invention relates to a hydraulic brake, and particularly to a semi-hydraulic brake for a bicycle.

2. Description of Related Art

A conventional brake for a bicycle is one pivotally mounted on a bike frame, working by means of clipping brake pads against a wheel rim.

A conventional disc brake for a bicycle can be divided into two main categories of mechanical and hydraulic brakes. The mechanical brake mainly uses a braking handlebar to pull a long cable so that the brake is driven to make brake pads to clip against the disc and thereby the braking effect can be achieved. The hydraulic brake uses a braking handlebar connected to a tube which is connected to a hydraulic system, thereby making the braking pads to clip against the disc and offering the braking effect.

Therefore, there is a need of a novel mechanic-hydraulic brake for a bicycle which offers more options for bicyclists.

### SUMMARY OF THE INVENTION

The object of the present invention is to provide a semi-hydraulic brake for a bicycle, which uses a single hydraulic cylinder to achieve the braking operation of a front wheel and a rear wheel.

In order to achieve the above and other objectives, the semi-hydraulic brake for a bicycle includes a set of mechanic units, having at least one braking cable and one connection rod, wherein one end of the braking cable is connected to a braking handlebar and the other end thereof is connected to one end of the connection rod; a hydraulic unit, having, at least one hydraulic cylinder, at least one pushing rod, at least one piston, at least one elastic element and at least one tube, wherein the connection rod is pivotally connected to the hydraulic cylinder; one end of the pushing rod is connected to connection rod, and the pushing rod drives the connection rod to move; there is at least one space inside the hydraulic cylinder for accommodating the pushing rod, the piston and the elastic element; one end of the pushing rod away from the connection rod urges against one side of the piston; one side of the piston away from the pushing rod urges against one end of the elastic element; one end of the elastic element away from the piston urges against one internal side of the hydraulic cylinder; and one end of the tube is connected to the hydraulic cylinder close to elastic element urges against the internal side of the hydraulic cylinder; and a set of braking units, connected to the tube and having a set of main pistons, a set of brake pads and a disc, wherein the main pistons are respectively mounted at either sides of the disc; both of the main pistons are respectively connected to one end of the tube; and the brake pads are respectively mounted to the corresponding main pistons close to the disc.

When the braking handlebar pulls the braking cable, the connection rod is driven to move toward the braking cable; the pushing rod is driven by the connection rod and meanwhile to push the piston and come to compress the elastic element; the braking liquid inside the hydraulic cylinder is pushed toward respective main pistons of the braking unit through the tube so that the respective main pistons move toward the disc; and the respective brake pads simultaneously move toward the disc. Thereby the braking effect can be achieved.

In order to further the understanding regarding the present invention, the following embodiments are provided along with illustrations to facilitate the disclosure of the present invention.

### BRIEF DESCRIPTION OF THE DRAWINGS

FIG. 1 is a schematic view of a semi-hydraulic brake for a bicycle according to the invention.

FIG. 2 is a top view of a semi-hydraulic brake for a bicycle according to the invention.

FIG. 3 is an enlarged view of parts of a mechanic unit and a hydraulic unit in the semi-hydraulic brake for a bicycle according to the invention.

FIG. 4 is an enlarged view of a part of a braking unit in the semi-hydraulic brake for a bicycle according to the invention.

FIG. 5 is a schematic view of operation of a semi-hydraulic brake of brake for a bicycle according to the invention.

FIG. 6 is a schematic view of operation of a mechanic unit and a hydraulic unit in the semi-hydraulic brake for a bicycle according to the invention.

FIG. 7 is a schematic view of operation of a braking unit in a semi-hydraulic brake for a bicycle according to the invention.

FIG. 8 is a schematic view of a hydraulic cylinder mounted on a front cross tube in a semi-hydraulic brake for a bicycle according to the invention.

FIG. 9 is a schematic view of a hydraulic cylinder integrally formed with a frame stem in a semi-hydraulic brake for a bicycle according to the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

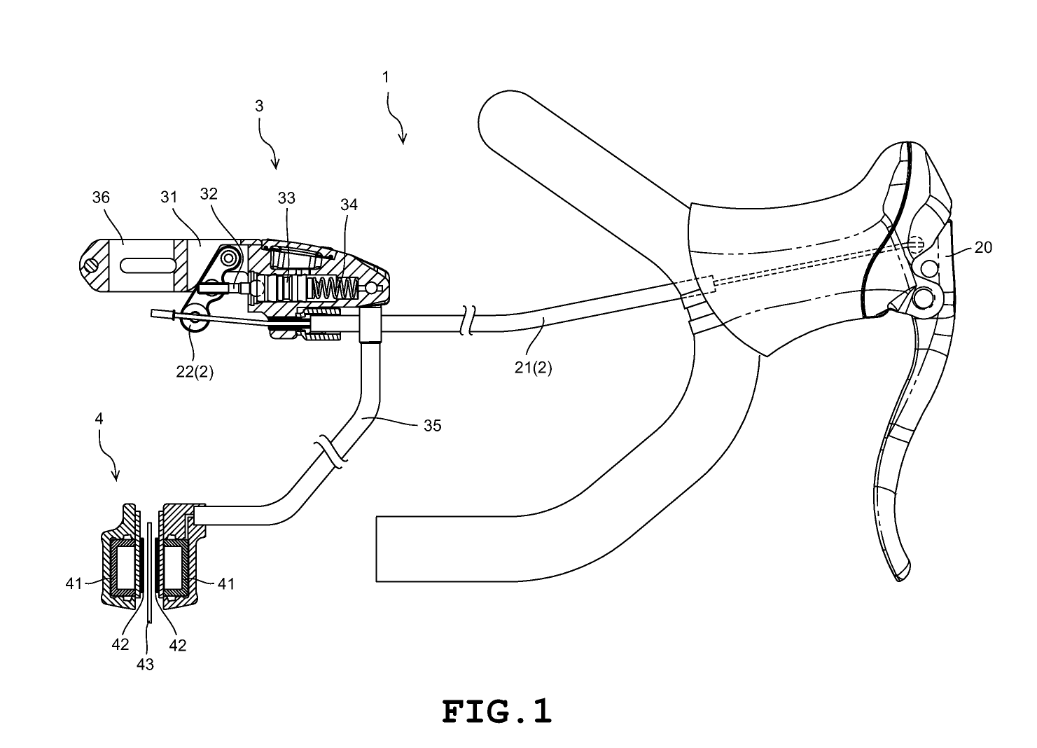

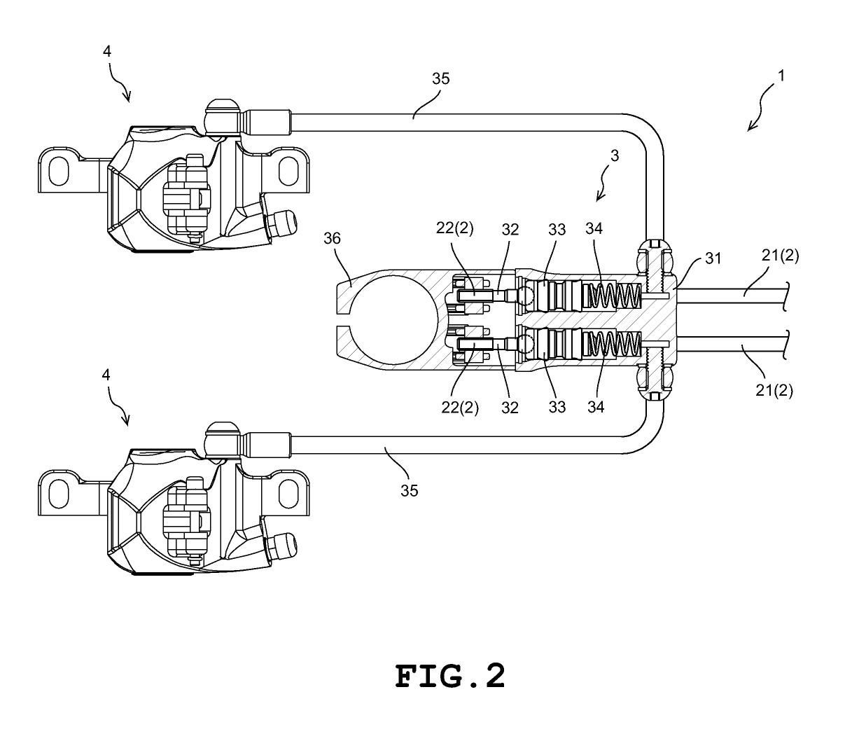

FIG. 1 is a schematic view of a semi-hydraulic brake for a bicycle according to the invention. FIG. 2 is a top view of a semi-hydraulic brake for a bicycle according to the invention.

Referring to FIG. 1 and FIG. 2, the semi-hydraulic brake 1 includes a set of mechanic units 2, a hydraulic unit 3 and a set of braking units 4.

A bicycle (not shown) has a front wheel and a rear wheel both of which needs braking effect. In the semi-hydraulic brake 1 of this invention, there may be two sets of braking units 4. One set is used to control the braking of the front wheel and locates at the front wheel, while the other set is used to control the braking of the rear wheel and locates at the rear wheel.

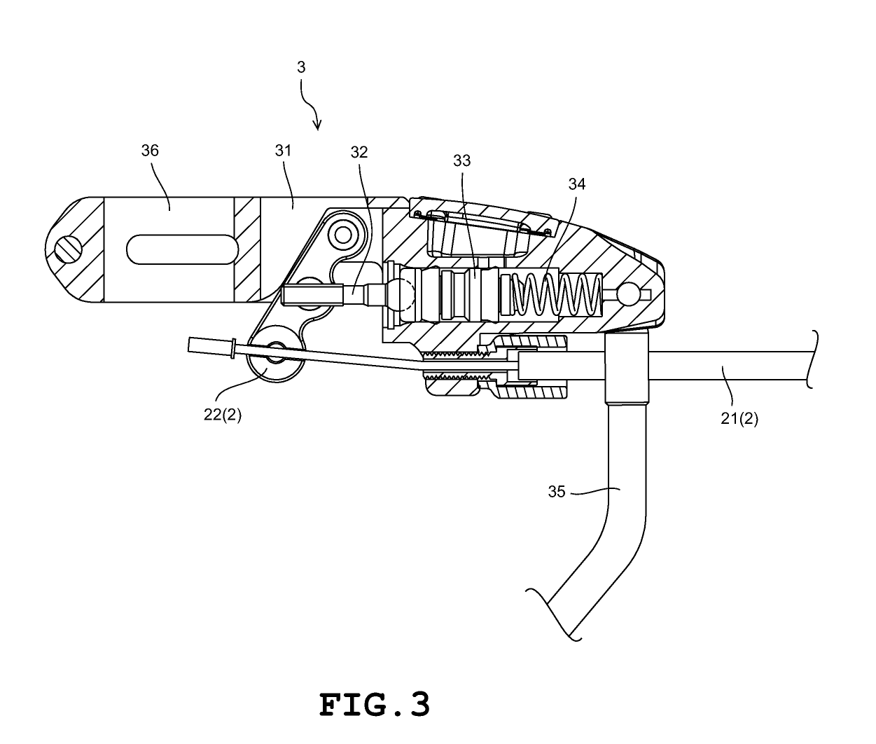

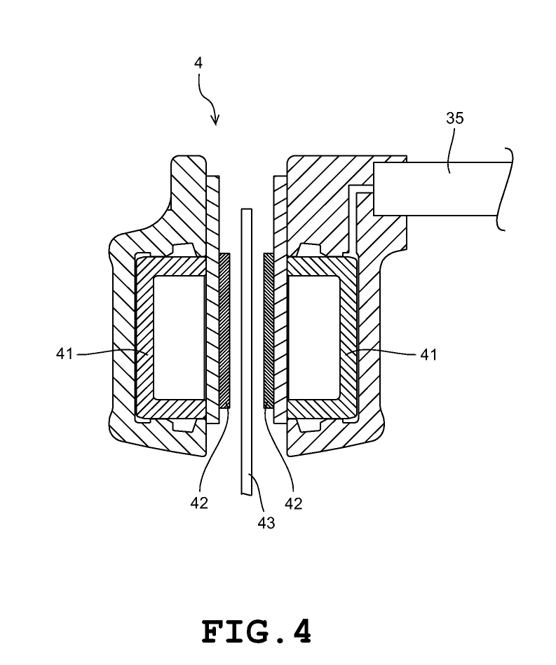

FIG. 3 is an enlarged view of parts of a mechanic unit and a hydraulic unit in the semi-hydraulic brake for a bicycle according to the invention. FIG. 4 is an enlarged view of a part of a braking unit in the semi-hydraulic brake for a bicycle according to the invention.

The set of the mechanic units 2 includes two braking cables 21 and two connection rods 22. In this embodiment, one braking cable 21 and one connection rod 22 are exemplified for illustration. One end of the braking cable 21 is connected to a braking handlebar 20 and the other end thereof is connected to one end of the connection rod 22.

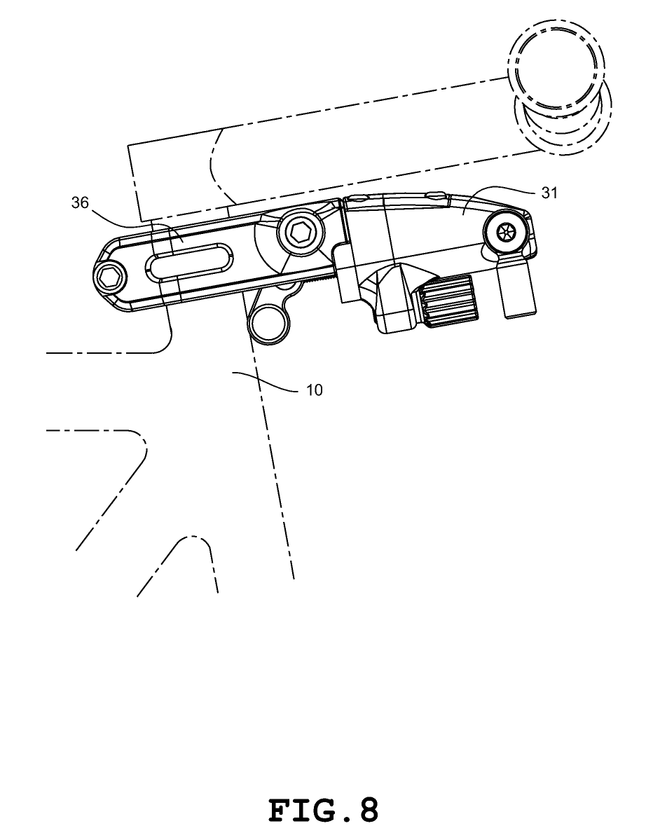

The hydraulic unit 3 includes a hydraulic cylinder 31, two pushing rods 32, two pistons 33, two elastic elements 34 and two tubes 35. The connection rod 22 is pivotally connected to the hydraulic cylinder 31. There are two spaces inside the hydraulic cylinder 31 for accommodating each of the pushing rods 32, the pistons 33 and the elastic elements 34. The tubes 35 are respectively disposed corresponding to the elastic elements 34. The hydraulic cylinder 31 further has a quick-disassembled element 36 by which the hydraulic cylinder 31 can be detachably fixed onto a front cross tube 10 (shown in FIG. 8) of a bicycle (not shown). Alternately, the hydraulic cylinder 31 is directly formed onto the front cross tube 10 of a bicycle. The elastic element 34 can be a compressed spring.

One end of the pushing rod 32 is connected to the connection rod 22. Specifically, one end of the pushing rod 32 is connected between a pivoting part of the connection rod 22 and one end of the connection rod 22 connecting to the braking cable 21, so that the pushing rod 32 drives the connection rod 22 to move. The piston 33 and the elastic element 34 can be movably mounted inside the hydraulic cylinder 31. One end of the connection rod 22 away from the pushing rod 32 urges against one side of the piston 33. One side of the piston 33 away from the pushing rod 32 urges against one end of the elastic element 34. One end of the elastic element 34 away from the piston 33 urges against one internal side of the hydraulic cylinder 31. One end of the tube 35 is connected to the hydraulic cylinder 31 close to elastic element 34 urges against the internal side of the hydraulic cylinder 31.

The braking unit 4 is connected to the tube 35, and has a set of main pistons 41, a set of brake pads 42 and a disc 43. One main piston 41 is mounted at one side of the disc 43 and the other main piston 41 is mounted at the other side of the disc 43. Both of the main pistons 41 are respectively connected to one end of the tube 35 away from the hydraulic cylinder 31. The brake pads 42 are respectively mounted to the corresponding main pistons 41 close to the disc 43.

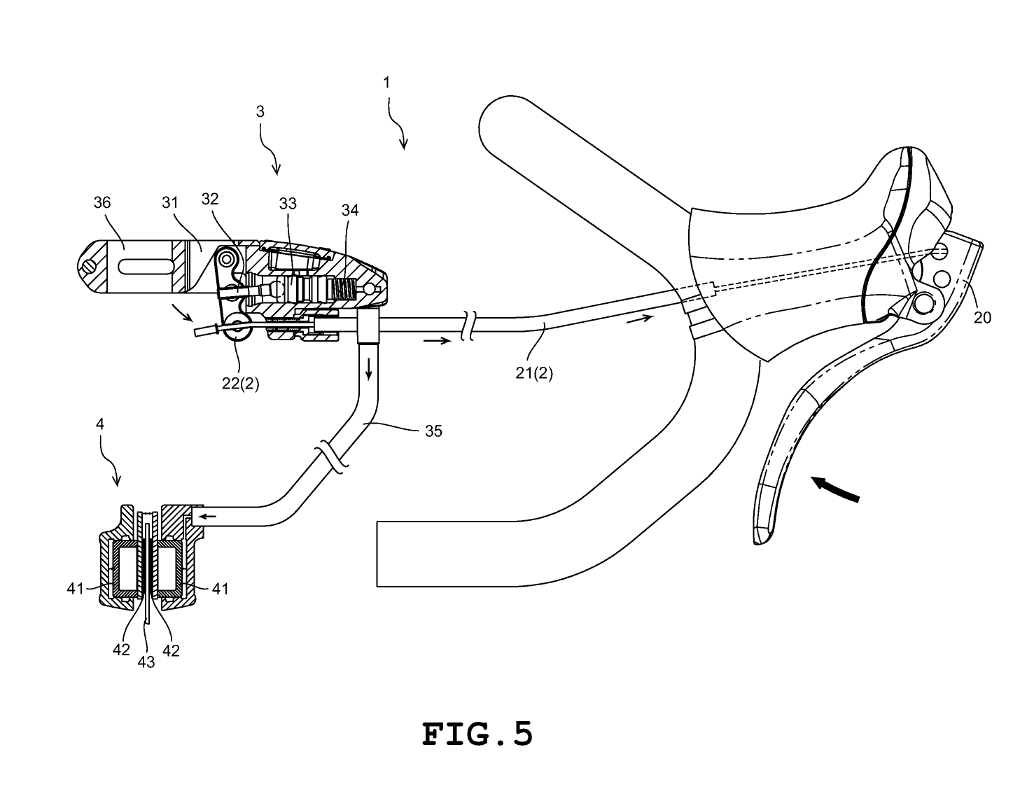

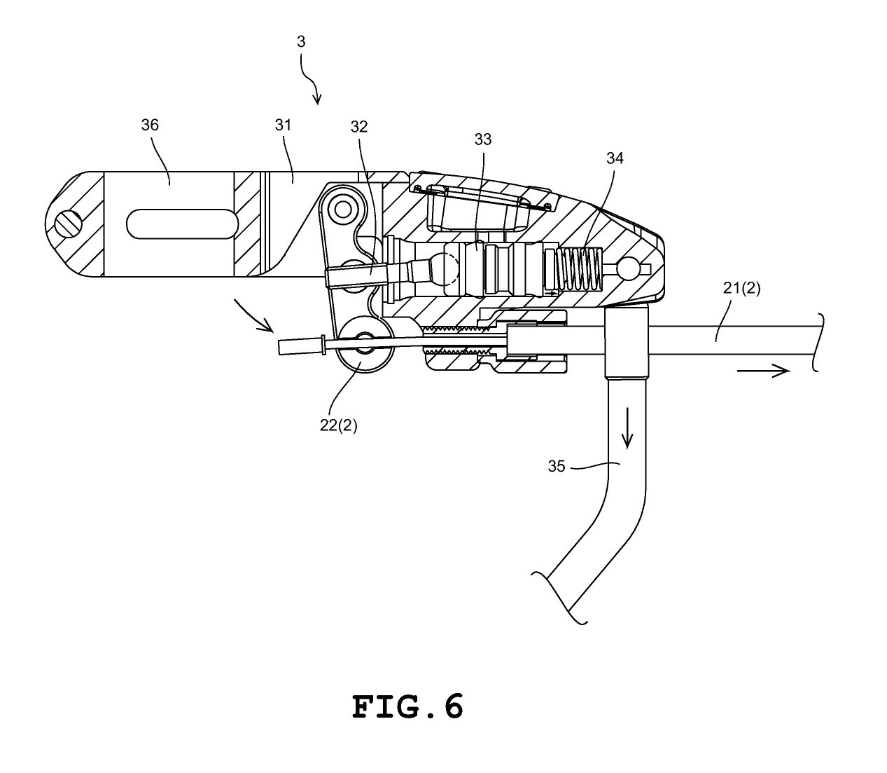

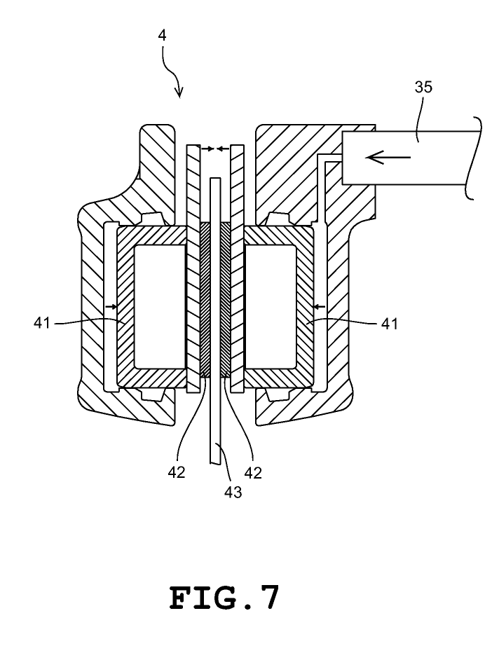

FIG. 5 is a schematic view of operation of a semi-hydraulic brake of brake for a bicycle according to the invention. FIG. 6 is a schematic view of operation of a mechanic unit and a hydraulic unit in the semi-hydraulic brake for a bicycle according to the invention. FIG. 7 is a schematic view of operation of a braking unit in a semi-hydraulic brake for a bicycle according to the invention.

Referring to FIG. 5 through FIG. 7, when the braking handlebar 20 pulls the braking cable 21, the connection rod 22 is driven to move toward the braking cable 21. The pushing rod 32 is driven by the connection rod 22 and meanwhile to push the piston 33 and come to compress the elastic element 34. The braking liquid inside the hydraulic cylinder 31 is pushed toward respective main pistons 41 of the braking unit 4 through the tube 35 so that the respective main pistons 41 move toward the disc 43. The respective brake pads 42 simultaneously move toward the disc 43 as well. Thereby, the braking operation can be achieved.

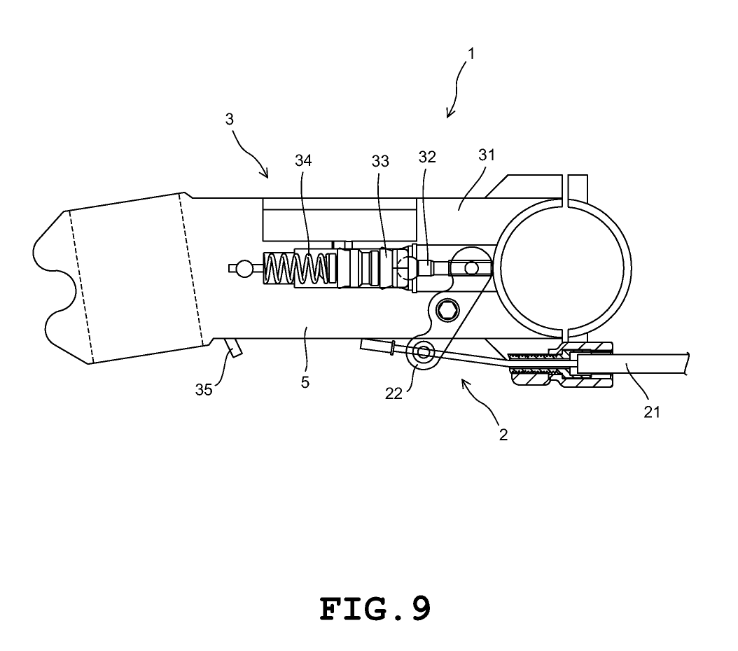

FIG. 9 is a schematic view of a hydraulic cylinder integrally formed with a frame stem 5 in a semi-hydraulic brake for a bicycle according to the invention. Referring to FIG. 9, the semi-hydraulic brake 1 of the invention includes a set of mechanic units 2, a hydraulic unit 3 and a set of braking units 4.

The set of mechanic units 2 includes two braking cables 21 and two connection rods 22. In this embodiment, one braking cable 21 and one connection rod 22 are exemplified for illustration. One end of the braking cable 21 is connected to a braking handlebar 20 and the other end thereof is connected to one end of the connection rod 22.

The hydraulic unit 3 includes a hydraulic cylinder 31, two pushing rods 32, two pistons 33, two elastic elements 34 and two tubes 35. The hydraulic cylinder 31 is integrally formed with the frame stem 5, and the connection rod 22 is pivotally connected to the hydraulic cylinder 31. There are two spaces inside the hydraulic cylinder 31 for accommodating each of the pushing rods 32, the pistons 33 and the elastic elements 34. The tubes 35 are respectively disposed corresponding to the elastic elements 34. The elastic element 34 can be a compressed spring.

One end of the pushing rod 32 is connected to the connection rod 22. Specifically, one end of the pushing rod 32 is connected between a pivoting part of the connection rod 22 and one end of the connection rod 22 away from the braking cable 21, so that the pushing rod 32 drives the connection rod 22 to move. The piston 33 and the elastic element 34 can be movably mounted inside the hydraulic cylinder 31. One end of the pushing rod 32 away from the connection rod 22 urges against one side of the piston 33. One side of the piston 33 away from the pushing rod 32 urges against one end of the elastic element 34. One end of the elastic element 34 away from the piston 33 urges against one internal side of the hydraulic cylinder 31. One end of the tube 35 is connected to the hydraulic cylinder 31 close to elastic element 34 urges against the internal side of the hydraulic cylinder 31.

The braking unit 4 is connected to the tube 35, and has a set of main pistons 41, a set of brake pads 42 and a disc 43. One main piston 41 is mounted at one side of the disc 43 and the other main piston 41 is mounted at the other side of the disc 43. Both of the main pistons 41 are respectively connected to one end of the tube 35 away from the hydraulic cylinder 31. The brake pads 42 are respectively mounted to the corresponding main pistons 41 close to the disc 43.

When the braking handlebar 20 pulls the braking cable 21, the connection rod 22 is driven to move toward the braking cable 21. The pushing rod 32 is driven by the connection rod 22 and meanwhile to push the piston 33 to act, and come to compress the elastic element 34. The braking liquid inside the hydraulic cylinder 31 is pushed toward respective main pistons 41 of the braking unit 4 through the tube 35 so that the respective main pistons 41 move toward the disc 43. The respective brake pads 42 simultaneously move toward the disc 43 as well. Thereby, the braking operation can be achieved.

In the above structure, a single hydraulic cylinder 31 can reach the braking effect over the front wheel and the rear wheel. Thereby, the semi-hydraulic brake can be achieved with simplified structure and reduced cost and can be operated easily.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A semi-hydraulic brake, comprising:
a set of mechanic units, having at least one braking cable and one connection rod, wherein one end of the braking cable is connected to a braking handlebar and the other end thereof is connected to one end of the connection rod;
a hydraulic unit, having, at least one pushing rod, at least one piston, at least one elastic element and at least one tube, wherein the connection rod is pivotally connected to the hydraulic cylinder; one end of the pushing rod is connected to connection rod, and the pushing rod drives the connection rod to move; there is at least one space inside the hydraulic cylinder for accommodating the pushing rod, the piston and the elastic element; one end of the pushing rod away from the connection rod urges against one side of the piston; one side of the piston away from the pushing rod urges against one end of the elastic element; one end of the elastic element sway from the piston urges against one internal side of the hydraulic cylinder; and one end of the tube is connected to the hydraulic cylinder close to elastic element urges against the internal side of the hydraulic cylinder; and
a set of braking units, connected to the tube and having a set of main pistons, a set of brake pads and a disc, wherein the main pistons are respectively mounted at either sides of the disc; both of the main pistons are respectively connected to one end of the tube; and the brake pads are respectively mounted to the corresponding main pistons close to the disc.

2. The semi-hydraulic brake of claim 1, wherein when the braking handlebar pulls the braking cable, the connection rod is driven to move toward the braking cable; the pushing rod is driven by the connection rod and meanwhile to push the piston and come to compress the elastic element; the braking liquid inside the hydraulic cylinder is pushed toward respective main pistons of the braking unit through the tube so that the respective main pistons move toward the disc; and the respective brake pads simultaneously move toward the disc.

3. The semi-hydraulic brake of claim 1, wherein one of the braking units is mounted at a rear wheel of a bicycle.

4. The semi-hydraulic brake of claim 1, wherein one of the braking units is mounted at a front wheel of a bicycle.

5. The semi-hydraulic brake of claim 1, wherein the hydraulic cylinder has a quick-disassembled element by which the hydraulic cylinder is detachably fixed onto a front cross tube.

6. The semi-hydraulic brake of claim 1, wherein one end of the pushing rod is connected between a pivoting part of the connection rod and one end of the connection rod connecting to the braking cable.

7. The semi-hydraulic brake of claim 1, wherein one end of the pushing rod is connected between a pivoting part of the connection rod and one end of the connection rod away from the braking cable.

8. The semi-hydraulic brake of claim 1, wherein the hydraulic cylinder is integrally formed with a frame stem.
